(19) United States
(12) Patent Application Publication
(10) Pub. No.: US 2003/0101594 A1
(43) Pub. Date: Jun. 5, 2003

(54) Cold knife attachment tool

(76) Inventor: Eric David Diemert, Mobile, AL (US)

Correspondence Address: Eric David Diemert, 1625 Ward Wood dr., Mobile, AL, 36605, US

(21) Appl. No.: 09/950,217

(22) Filed: Dec. 5, 2001

(51) Int. Cl. B26B 3/00

(52) U.S. Cl. 30/314; 30/169

(57) ABSTRACT

Any tool used to be attached to a cold knife for the purpose of pushing or pulling a cold knife in removal of auto windshields. Made of either metal or plastic.

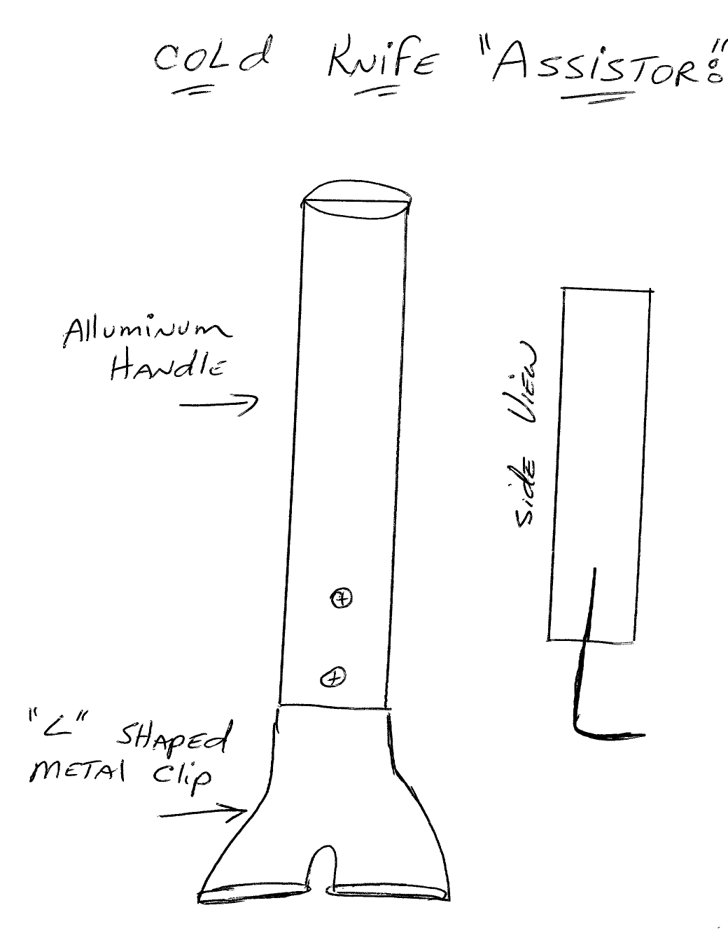

### BACKGROUND OF THE INVENTION

1. Field of the Invention

This invention relates to the tools used in automobile windshield replacement, and more specifically to the removal of damaged windshields.

2. Description of Act of Tool

The purpose of the tool is to assist in the use of an existing tool, the cold knife, necessary in cutting out automotive glass.

3. The Principal Object of Tool

The cold knife is designed to only be pulled. This tool attaches to the cold knife and enables it to not only be pulled but to also be pushed.

### SUMMARY OF THE INVENTION

It consists of the handle of a cold knife, and a small “L” shaped clip attached with screws. It attaches to and releases from the cold knife for easy use. The handle is made of aluminum and the “L” shaped clip is rubber-coated steel. The rubber coating is to prevent scratching the automobile's paint.

### DETAILED DESCRIPTION

The Assistor is a curved piece of metal that is fastened into a large handle commonly used in the cold knife. When used this second handle allows you to push a cold knife away from you with out damaging strain on your hand. This problem presents itself after you have cut the side post and around the curve at the top of the glass. You must push the cold knife to near the center of the vehicle so you can reach it from the other side. To use this tool, you attach it to the pull handle of the cold knife as you round the top corner, push the cold knife as far as possible across the top of the vehicle using this handle. Next, go to the other side, and you can continue using the Assistor, or, simply remove it. Pull the cold knife the rest of the way across the top and down the other side before removing the cold knife. When removing a glass it is not uncommon for it to be necessary to start the cold knife at the bottom of the glass and not be able to remove the cold knife until you have reached the bottom of the other side. This is why the tool is important.

What I now claim is:

1. The Cold Knife Assistor, is a “L” shaped clip and handle The “clip” is fastened to the handle that it commonly used in an existing tool (the cold knife). It provides the ability to “push” the blade through the urethane in order to release the automobile's windshield. It is a simple, yet innovative tool that could greatly benefit the industry of automobile windshield replacement.
